(19) United States
(12) Patent Application Publication
(10) Pub. No.: US 2025/0073741 A1
(43) Pub. Date: Mar. 6, 2025

(54) SYSTEMS AND METHODS FOR APPLYING VISCOUS MATERIAL TO FASTENERS

(71) Applicants: The Boeing Company, Arlington, VA (US); Strata Manufacturing PJSC, Al Ain (AE)

(72) Inventors: Jason Cochrane, Melbourne (AU); Ashkan Amirsadri, Melbourne (AU); Bittu Scaria, Al Ain (AE); Andre Dewald Swart, Al Ain (AE)

(73) Assignees: The Boeing Company, Arlington, VA (US); Strata Manufacturing PJSC, Al Ain (AE)

(21) Appl. No.: 18/460,830

(22) Filed: Sep. 5, 2023

(51) Int. Cl. B05C 11/10; B05C 1/02

(52) U.S. Cl. CPC B05C 11/10; B05C 1/02

(57) ABSTRACT

A system includes a power-circulating transmission having a plurality of transmission components arranged in series to circulate motion along a continuous loop and a test article coupled to the power-circulating transmission. The system includes a clutch, a brake, a starting-torque motor, a running motor, and a running-torque motor. The brake selectively couples or decouples the transmission components such that the power-circulating transmission is in an engaged or disengaged power-circulating state. The brake selectively inhibits motion of one of the transmission components when the power-circulating transmission is in the disengaged power-circulating state. The starting-torque motor applies a static torque load to the power-circulating transmission. The running motor applies power to the power-circulating transmission to drive the motion along the continuous. The running-torque motor applies a dynamic torque load to the power-circulating transmission.

### FIELD

The present disclosure relates generally to fasteners and, more particularly, to systems and methods for applying viscous material to fasteners, such as sealant to the surface of a nut plate.

### BACKGROUND

Fasteners, such as nut plates, are utilized to secure two components of a structure together. In some applications, such as aerospace applications, it may be necessary to apply a sealant, an adhesive, or other viscous material to the surface of the fastener. Manual application of such materials is time consuming, labor intensive, and prone to inconsistencies. Robotic application of these materials is also time consuming and presents challenges in achieving full surface coverage. Accordingly, those skilled in the art continue with research and development efforts in the application of viscous material to surfaces of fasteners.

### SUMMARY

Disclosed are examples of a system for applying viscous material to a fastener and a method for applying viscous material to a fastener. The following is a non-exhaustive list of examples, which may or may not be claimed, of the subject smatter according to the present disclosure.

In an example, the disclosed system includes a carrier that supports viscous material. The system includes a dispenser that dispenses the viscous material on the carrier. The system includes an applicator that supports at least one of the carrier and the fastener and transfers a portion of the viscous material from the carrier to the fastener.

In another example, the disclosed system includes a carrier that supports viscous material. The system includes a dispenser that dispenses the viscous material on the carrier. The system includes an end effector that manipulates the fastener. The system includes a robotic arm that moves the end effector relative to the carrier. The system includes a carrier-support that supports the carrier during transfer of a portion of the viscous material from the carrier to the fastener.

In an example, the disclosed method includes steps of: (1) holding a fastener; (2) moving a carrier along a processing path relative to a dispenser; (3) while moving the carrier along the processing path, dispensing viscous material from the dispenser onto a carrier-surface of the carrier; (4) after dispensing the viscous material, moving the carrier along the processing path relative to the fastener; (5) pausing movement of the carrier along the processing path; (6) while pausing movement of the carrier along the processing path, moving at least one of the carrier and the fastener toward each other; and (7) transferring a portion of the viscous material from the carrier-surface of the carrier to a fastener-surface of the fastener.

Other examples of the system and the method will become apparent from the following detailed description, the accompanying drawings, and the appended claims.

### BRIEF DESCRIPTION OF THE DRAWINGS

FIG. 1 is a schematic, perspective view of an example of a system for applying sealant to a fastener;

FIG. 2 is a schematic, perspective view of an example of the system;

FIG. 3 is a schematic, perspective view of an example of the system;

FIG. 4 is a schematic, elevation view of an example of the system;

FIG. 5 is a schematic, plan view of an example of the system;

FIG. 6 is a schematic, perspective view of an example of the system;

FIG. 7 is a schematic, perspective view of an example of a portion of the system;

FIG. 8 is a schematic, elevation view of an example of a portion of the system;

FIG. 9 is a schematic, perspective view of an example of a portion of the system;

FIG. 10 is a schematic, perspective view of an example of a portion of the system;

FIG. 11 is a schematic, perspective view of an example of a portion of the system;

FIG. 12 is a schematic, perspective view of an example of a portion of the system;

FIG. 13 is a schematic, perspective view of an example of a portion of the system;

FIG. 14 is a schematic, perspective view of an example of a nozzle;

FIG. 15 is a schematic, end view of an example of the nozzle; and

FIG. 16 is a schematic, section view of an example of the nozzle;

FIG. 17 is a schematic, plan view of an example of a strip of the viscous material on a carrier;

FIG. 18 is a schematic, elevation view of an example of the strip of the viscous material on the carrier and an example of the fastener;

FIG. 19 is a schematic, elevation view of an example of the system holding a fastener;

FIG. 20 is a schematic, elevation view of an example of the system applying viscous material to the fastener;

FIG. 21 is a schematic, block diagram of an example of the system;

FIG. 22 is a flow diagram of an example of a method for applying viscous material to a fastener;

FIG. 23 is a flow diagram of an example of an aircraft manufacturing and service method; and

FIG. 24 is a schematic block diagram of an example of an aircraft.

### DETAILED DESCRIPTION

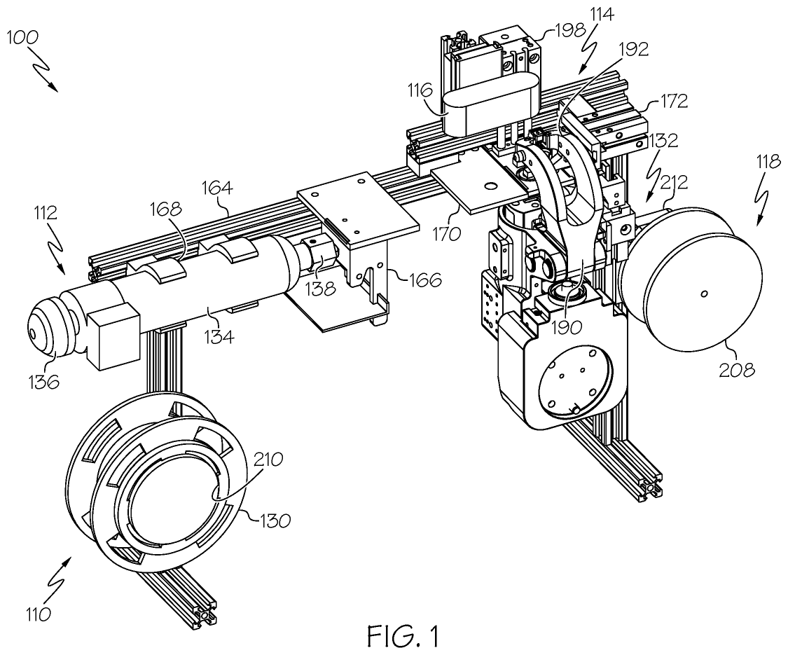

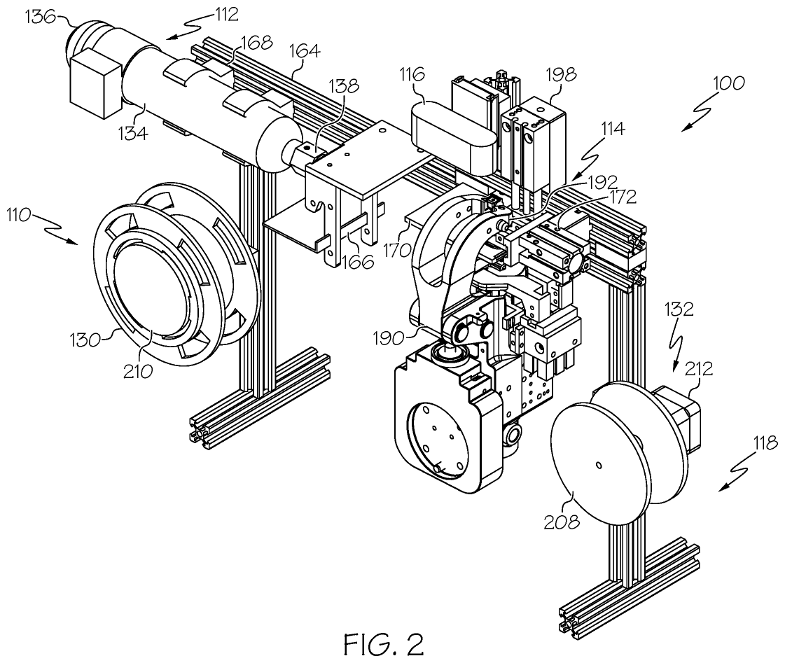

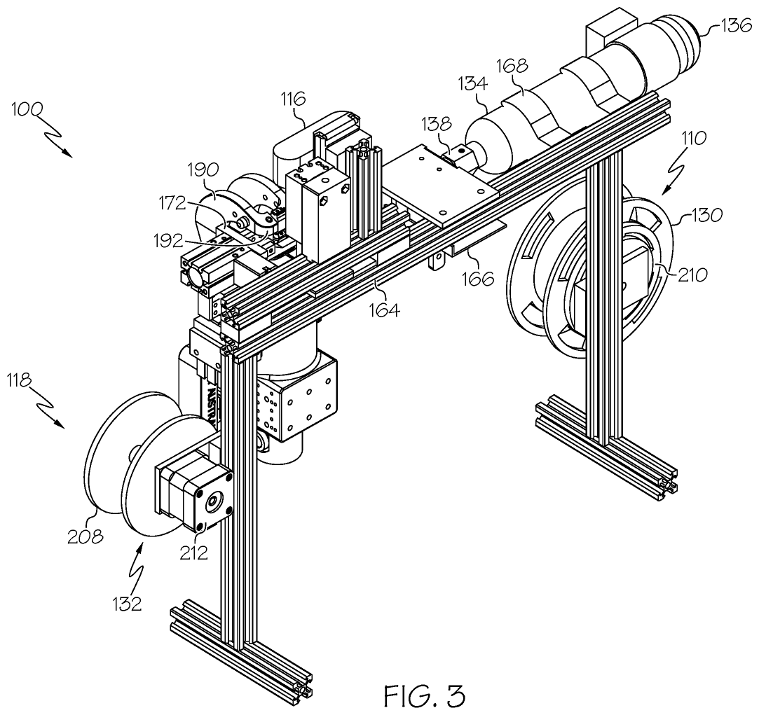

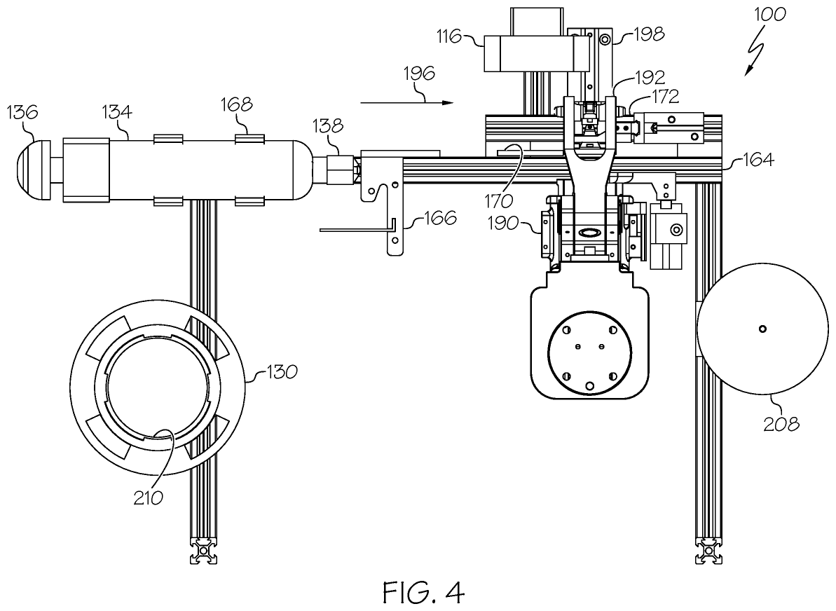

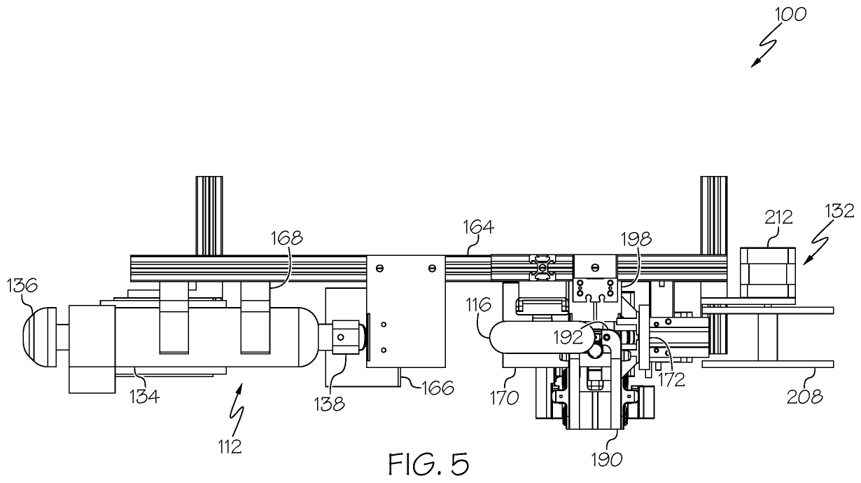

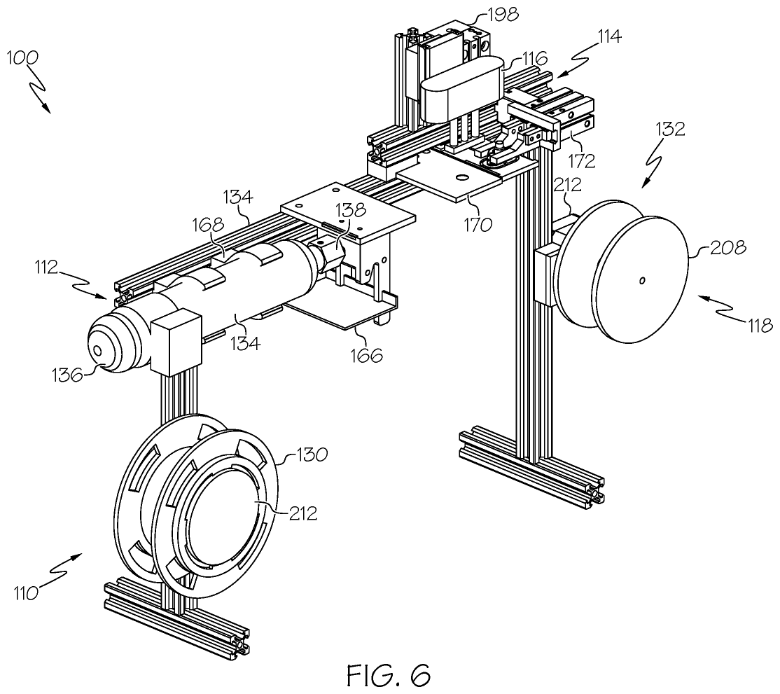

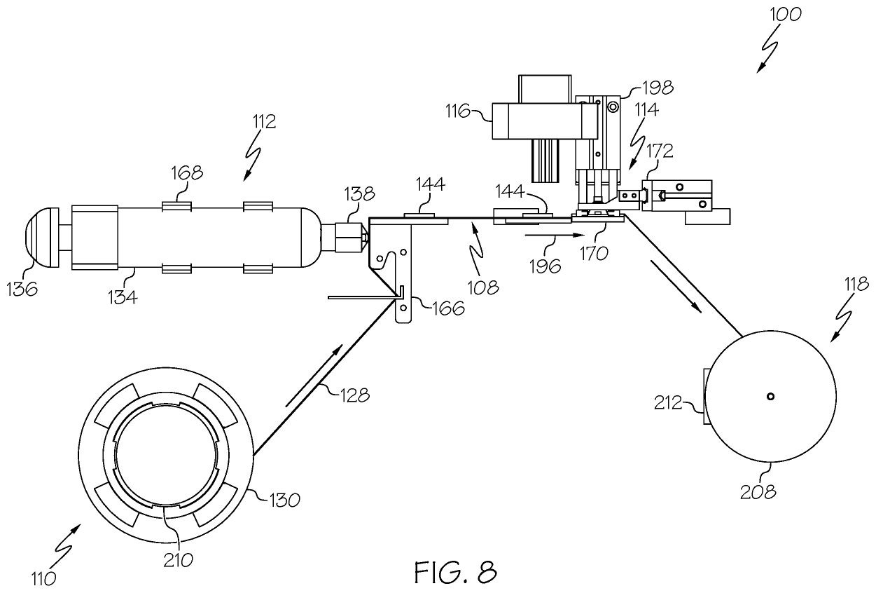

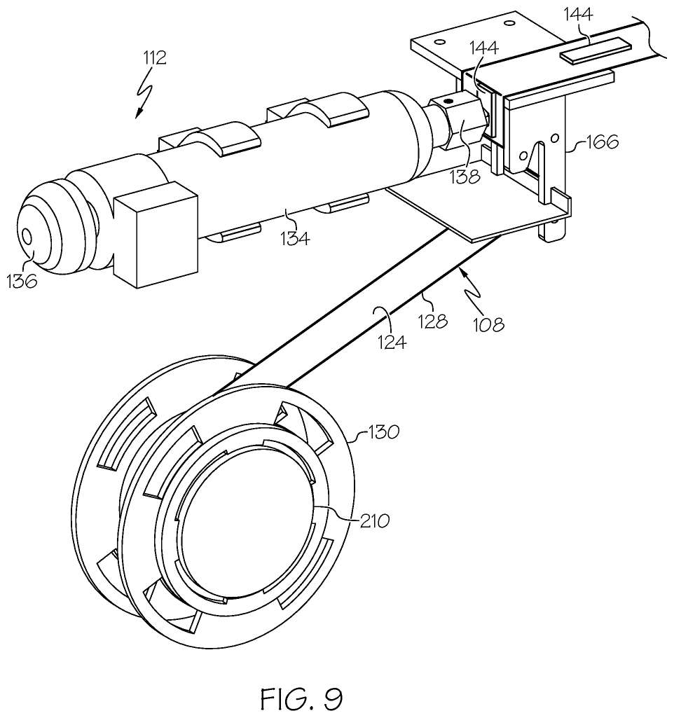

Referring generally to FIGS. 1-22, by way of examples, the present disclosure is directed to a system 100 and a method 1000 for applying viscous material 102 to a fastener-surface 106 of a fastener 104. The system 100 and method 1000 enable application of a proper (e.g., controlled or desired) amount of the viscous material 102 to the fastener-surface 106 prior to installation of the fastener 104.

For the purpose of the present disclosure, the viscous material 102 refers to or includes a substance or material having a relatively thick and/or sticky consistency between solid and liquid or having a relatively high viscosity. An example of the viscous material 102 includes a sealant 120, such as, but are not limited to, substances used to fill, close, block, or seal holes, gaps, cracks, or openings. Another example of the viscous material 102 includes an adhesive 122, such as, but not limited to, substances used to bond surfaces together. The particular type of the viscous material 102 applied to the fastener 104 may depend on the purpose of the viscous material 102 and/or the purpose or type of the fastener 104 being used.

For the purpose of the present disclosure, the fastener 104 refers to or includes a hardware device that mechanically joins or affixes two or more objects together. As an example. fastener 104 includes a nut plate 206. Generally, the nut plate 206 is a self-wrenching, self-locking nut that is used in constrained areas to provide a permanent nut element on the inside of a joint, for example, so that an access panel, fairing, or other element can be attached with a screw, bolt, or other fastener. As an example, the nut plate 206 includes a base plate that defines a pair of opposed plate flanges and a nut that is operatively attached to the base plate and defines a threaded central opening. In these examples, the fastener-surface 106 is a surface of the base plate that engages a surface of one of the components being joined together. In other examples, the fastener 104 includes other suitable types of mechanical fasteners used to create non-permanent joints or joints that can be removed or dismantled without damaging the joining components.

The present disclosure recognizes that automated application of viscous materials, such as sealants and adhesives, to surfaces of fasteners and other components of manufactured structures provides advantages over manual application. However, the present disclosure also recognizes that improvements in automated application of viscous materials are needed. Automated application of viscous materials typically uses robots or other multi-axis computer-controlled machines to apply viscous materials by tracing a predetermined path against an application surface of the component while dispensing the viscous material from a nozzle in the form of a bead. However, this process is generally very slow and is prone to inconsistencies due to challenges in controlling the starting-point and stopping-point the bead of viscous material along the traced path, which can compromise coverage. Ultimately, the end result for surface coverage is a series of beads, rather than full face coverage. This means the full coverage of the component across the entire application surface is unknown and unverifiable.

FIGS. 1-8 schematically illustrate examples of the system 100. As illustrated, in the various examples disclosed herein, the system 100 and method 1000 provide conveyor-style delivery of the viscous material to fasteners and full-surface coverage. Viscous material is dispensed on the surface of a carrier. A fastener is securely held by a gripper or an end effector, and the carrier is conveyed to the location of the fastener. The fastener is then “dipped” into the viscous material and compressed against the carrier to completely cover the application surface of the fastener. Accordingly, the system 100 and the method 1000 beneficially enable the viscous material 102 to be consistently applied to a desired portion of or an entirety of the fastener-surface 106 of the fastener 104, such as an entire contact or faying surface of the nut plate 206, in a single automated motion or operation. The system 100 and method 1000 also enable coverage of the viscous material 102 to be verified after application.

Referring now to FIGS. 1-21, the following are examples of the system 100, according to the present disclosure. The system 100 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIGS. 1-8 and 21, in one or more examples, the system 100 includes a carrier 108, a dispenser 112, and an applicator 114. The carrier 108 is configured to support the viscous material 102 for conveyance to the fastener 104 and application on the fastener-surface 106 of the fastener 104. The dispenser 112 is configured to dispense the viscous material 102 on the carrier 108. The applicator 114 is configured to support at least one of the carrier 108 and the fastener 104 during application of the viscous material 102 to the fastener-surface 106 of the fastener 104. The applicator 114 is also configured to transfer a portion of the viscous material 102 from the carrier 108 to the fastener 104.

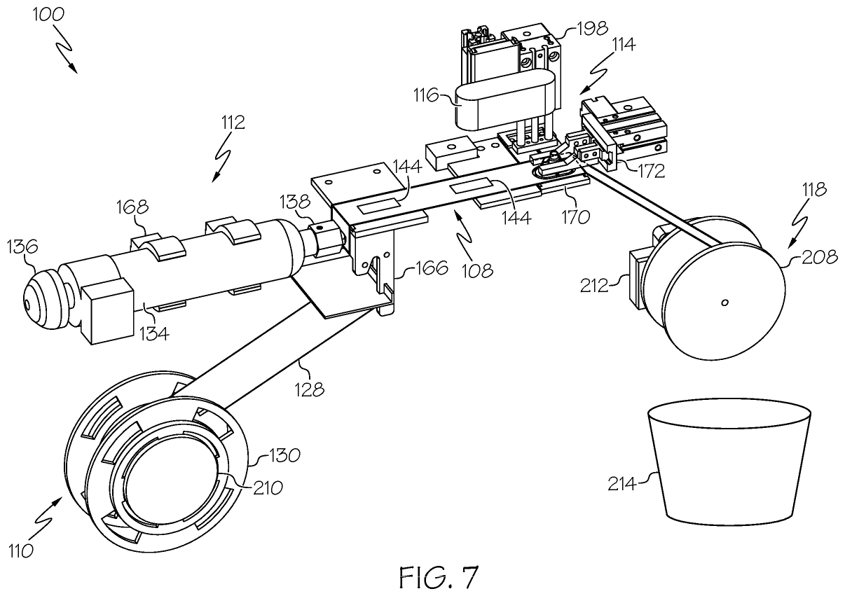

FIGS. 7 and 8 schematically illustrate examples of the system 100 depicting an example of the carrier 108. In one or more examples, the carrier 108 is movable. As an example, the carrier 108 is movable relative to the dispenser 112. As another example, the carrier 108 is movable relative to the applicator 114. Movement of the carrier 108 relative to the dispenser 112 conveys a carrier-surface 124 to the dispenser 112 such that a desired amount of the viscous material 102 can be dispensed on the carrier-surface 124 of the carrier 108. Movement of the carrier 108 relative to the applicator 114 conveys the viscous material 102 to the fastener 104 such that the viscous material 102 can be transferred onto the fastener-surface 106 of the fastener 104.

Referring to FIGS. 7, 8 and 21, in one or more examples, the carrier 108 includes or takes the form of a substrate 126. The substrate 126 forms the carrier-surface 124 that supports the viscous material 102 dispensed by the dispenser 112. The substrate 126 can be any underlying layer of material capable of supporting the viscous material 102 and moving the viscous material 102 to the location of the fastener 104. In one or more examples, the substrate 126 is a thin sheet of material. The substrate 126 can be made of a natural material or a synthetic material. Examples of materials that can be used to form the substrate 126 include, but are not limited to, paper, plastic, film, cloth, foil, foam, and the like. The substrate 126 can be disposable or reusable.

Referring to FIGS. 1-8 and 21, in one or more examples, the system 100 includes a feeder 110. The feeder 110 is configured to move the substrate 126 relative to the dispenser 112 and the applicator 114. The feeder 110 generally includes a support-component that is configured to support the carrier 108 during at least a portion of the application operation and a drive-component that is configured to move the carrier 108 along a processing path 196.

Referring to FIGS. 1-7, 8 and 21, in one or more examples, the substrate 126 includes or takes the form of a continuous length of tape 128. The tape 128 is generally a long, narrow strip of material. In these examples, the feeder 110 includes a roll 130 and a feeder-drive 132. The roll 130 stores or otherwise supports the tape 128 before and during the application operation. The feeder-drive 132 is configured to remove the tape 128 from the roll 130. The feeder-drive 132 is also configured to move the tape 128 relative to the dispenser 112 and the applicator 114.

In one or more examples, the roll 130 includes or takes the form of a supply roller 210 that is suitable positioned at a start of the processing path 196 and/or relative to the dispenser 112 to feed or otherwise supply the tape 128 to the dispenser 112 for discharge of the viscous material 102 on the carrier-surface 124 of the tape 128 and permit the tape 128 to move along the processing path 196. In one or more examples, the feeder-drive 132 includes one or more components that are configured to remove the tape 128 from the supply roller 210 and move the tape 128 along the processing path 196. As an example, the feeder-drive 132 includes a drive-motor (e.g., an electric motor, a pneumatic motor, or the like), a drive-roller, and/or one or more drive-pulleys that pull the tape 128 along the processing path 196. As an example, the drive-motor, drive-roller, and/or drive pulley are positioned at an end of the processing path 196 and opposite the supply roller 210. In one or more examples, the drive-roller includes a take-up roller 208 that grabs an end of the tape 128, pulls the tape 128, and collects the tape 128 after application of the viscous material 102 to the fastener 104. In these examples, a drive-motor 212 is coupled to the supply roller 210 and rotates the supply roller 210 to pull the tape 128 along the processing path 196 and collect the tape 128 after use.

In one or more examples, the feeder-drive 132 incrementally or intermittently progresses the tape 128 along the processing path 196 relative to the applicator 114. As an example, the feeder-drive 132, such as the drive-motor 212, is configured to or is otherwise selectively controlled to move the tape 128 along the processing path 196 in regular intervals (e.g., move, pause, move, pause, etc.). In these examples, the viscous material 102 is transferred from the tape 128 (e.g., carrier 108) to the fastener 104 during periods of paused movement of the tape 128. In one or more examples, the drive-motor 212 includes or takes the form of a stepper motor.

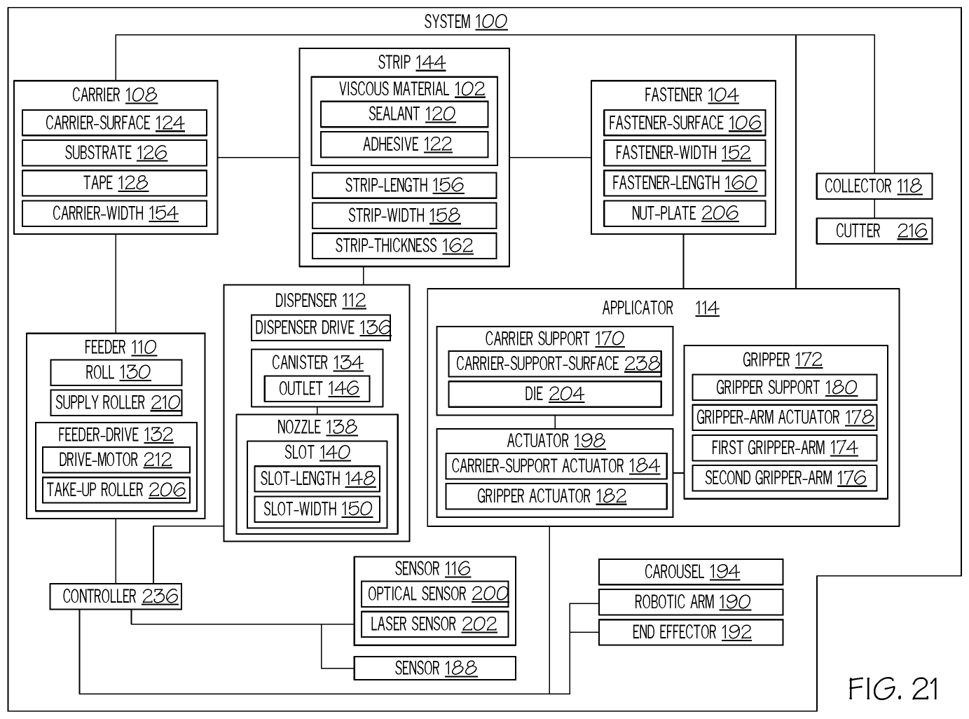

Referring to FIGS. 1-8 and 21, in one or more examples, the system 100 includes a collector 118. The collector 118 is configured to collect the tape 128 (or other forms of the carrier 108) after application of the viscous material 102 to the fastener 104. In one or more examples, the collector 118 and the feeder 110 are integrated or share components. As an example, the collector 118 may include or utilize the take-up roller 208 to collect the tape 128 after use. In one or more examples, the collector 118 includes a bin 214 that receives the carrier 108, such as the tape 128, after use. In one or more examples, the collector 118 can include a cutter 216 (FIG. 21) that cuts the tape 128 from the take-up roller 208 for deposition in the bin 214.

Referring to FIGS. 1-9 and 21, in one or more examples, the dispenser 112 includes a canister 134. The canister 134 is configured to hold the viscous material 102. The canister 134 includes an outlet 146 (FIG. 21). The dispenser 112 also includes a dispenser-drive 136 that forces the viscous material 102 from the canister 134 and through the outlet 146.

In one or more examples, the canister 134 is a standard (e.g., commercially available) canister used for the viscous material 102, such as a sealant canister. In one or more examples, the viscous material 102 is dispensed from the canister through the use of hydraulic (or other) pressure. In one or more examples, the viscous material 102 is dispensed from the outlet 146 of the canister 134 onto the carrier-surface 124 of the carrier 108 (e.g., the tape 128).

The dispenser-drive 136 can include any suitable mechanism or device that is capable of producing and/or transmitting a force on the volume of the viscous material 102 within the canister 134 to urge or otherwise drive the viscous material 102 through the outlet 146 of the canister 134. In one or more examples, the dispenser-drive 136 includes a pneumatic drive. In one or more examples, dispenser-drive 136 includes a mechanical drive. In one or more examples, the dispenser-drive 136 includes a hydraulic drive.

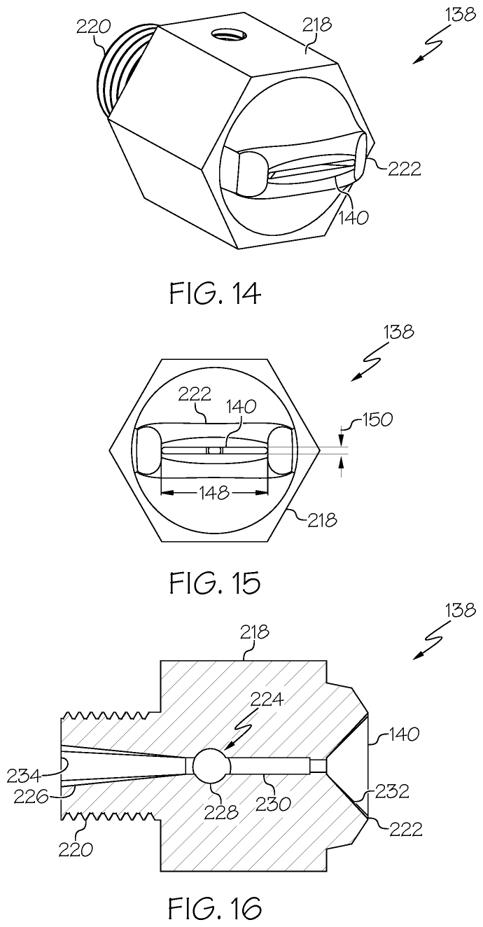

Referring to FIGS. 1-9, 14-16 and 21, in one or more examples, the dispenser 112 includes a nozzle 138. The nozzle 138 is coupled to the outlet 146 of the canister 134. The nozzle 138 includes a slot 140 (FIGS. 14-16. The slot 140 is configured to form a strip 144 of the viscous material 102 on the carrier 108 (FIGS. 7 and 8).

Referring to FIGS. 14-16 and 21, in one or more examples, the nozzle 138 is specially designed to provide a known or predetermined amount of the viscous material 102 and or to dispense the viscous material 102 in the form of the strip 144 that has a known or predetermined geometry or dimension (e.g., thickness). Additionally, the nozzle 138 is configured or designed such that a remnant of the viscous material 102 does not foul, collect, or harden within the slot 140, thereby allowing easy cleaning, such as after sealant cure. Moreover, the nozzle 138 can be made of inexpensive materials and by inexpensive manufacturing processes such that the nozzle 138 can be disposable after a number of uses.

Referring to FIGS. 14-16, in one or more examples, the nozzle 138 includes a nozzle-body 218, a connection-end 220 extending from the nozzle-body 218 along a longitudinal axis of the nozzle 138, and a discharge-end 222 extending from the nozzle-body 218 opposite the connection-end 220. The connection-end 220 is configured to be coupled to the canister 134, (e.g., threadably coupled within the outlet 146 of the canister 134), such that an inlet-opening 234 of the nozzle 138 is in fluid communication with an interior of the canister 134.

Referring to FIG. 16, in one or more examples, the nozzle 138 includes a channel 224 that extends through the nozzle-body 218 from the inlet-opening 234 at the connection-end 220 to the slot 140 at the discharge-end 222. In one or more examples, the channel 224 includes a channel first-portion 226, a channel second-portion 228. a channel third-portion 230, and a channel fourth-portion 232. The channel first-portion 226 is in fluid communication with and extends along the longitudinal axis of the nozzle 138 from the inlet-opening 234. The channel second-portion 228 is in fluid communication with and extends along the longitudinal axis of the nozzle 138 from the channel first-portion 226. The channel third-portion 230 is in fluid communication with and extends along the longitudinal axis of the nozzle 138 from the channel second-portion 228. The channel fourth-portion 232 is in fluid communication with and extends along the longitudinal axis of the nozzle 138 from the channel third-portion 230. The channel first-portion 226 tapers along the longitudinal axis of the nozzle 138 or otherwise has a sectional-dimension (e.g., diameter) that decreases from the inlet-opening 234 to the channel second-portion 228. The channel second-portion 228 has a sectional-dimension (e.g., diameter) that is larger than the sectional-dimension (e.g., diameter) of the channel first-portion 226. The channel third-portion 230 has a sectional-dimension (e.g., diameter) that is less than the sectional-dimension (e.g., diameter) of the channel second-portion 228. The channel fourth-portion 232 tapers along the longitudinal axis of the nozzle 138 or otherwise has a sectional-dimension that increases from the channel third-portion 230 to the slot 140.

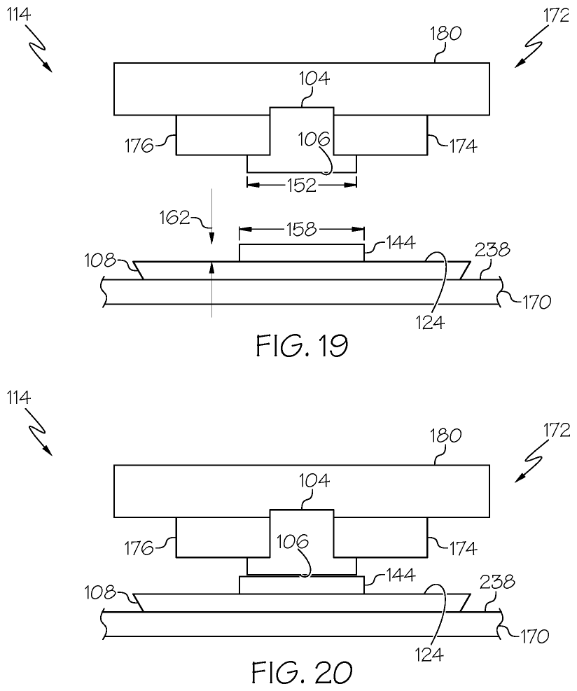

Referring to FIGS. 15 and 21, in one or more examples, the slot 140 includes a slot-length 148 and a slot-width 150. The slot-length 148 is greater than or equal to a fastener-width 152 (FIG. 19) of the fastener 104. The slot-length 148 is less than a carrier-width 154 (FIG. 19) of the carrier 108. The dimension of the slot-length 148 relative to the fastener-width 152 and the carrier-width 154 produces the strip 144 of the viscous material 102 that has a strip-width 158 that is greater than or equal to the fastener-width 152 and that is less than the carrier-width 154 to provide full coverage of the viscous material 102 on the fastener-surface 106. In these examples, the fastener-width 152 refers to the width-dimension of the fastener-surface 106, such as the width of the contact surface of the base plate of the nut plate 206.

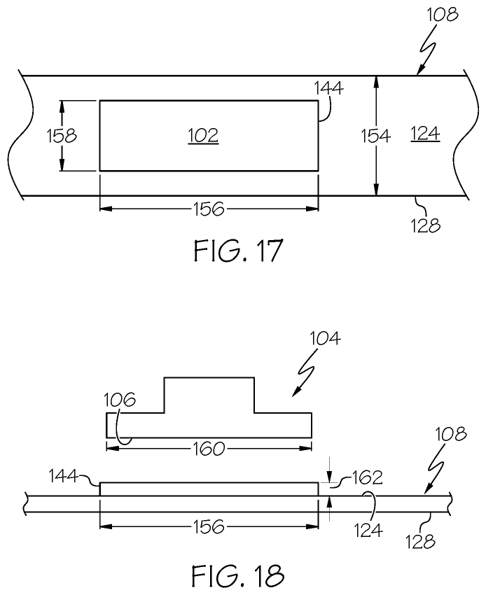

Referring to FIGS. 17, 18 and 21, in one or more examples, the dispenser-drive 136 is selectively actuated to dispense the viscous material 102 from the canister 134 (e.g., from the outlet 146 or the nozzle 138), such that the strip 144 of the viscous material 102 has a strip-length 156. The strip-length 156 is greater than a fastener-length 160 (FIG. 18) of the fastener 104. Selective actuation of the dispenser-drive 136 as the carrier 108 (e.g., the tape 128) moves relative to the nozzle 138 produces the strip 144 having the strip-length 156 suitable for coverage of the viscous material 102 on the fastener-surface 106. In an example, the dispenser-drive 136 is instructed and operated to dispense the viscous material 102 intermittently to form the strip 144.

Referring to FIGS. 18 and 21, in one or more examples, a speed of movement of the carrier 108 relative to the dispenser 112 and a dispense-rate of the viscous material 102 from the dispenser 112 are selectively controlled to control a strip-thickness 162 of the strip 144 of the viscous material 102. In one or more examples, the slot-width 150 is selected based on a desired dimension of the strip-thickness 162. The strip-thickness 162 has a significant impact on the degree of coverage of the viscous material 102 on the fastener-surface 106 when the viscous material 102 is transferred from the carrier 108 to the fastener 104. As an example, the feeder-drive 132 is instructed and operated to control or maintain movement of the carrier 108 at a desired or appropriate speed relative to the dispenser 112 to achieve the strip-thickness 162 needed for full coverage. The dispenser-drive 136 is instructed and operated to control or maintain discharge of the viscous material 102 from the dispenser 112 at a desired or appropriate dispense-rate to achieve the strip-thickness 162 needed for full coverage.

Referring to FIGS. 1-6 and 21, in one or more examples, the system 100 includes a frame 164. The frame 164 is configured to support the operational components of the system 100. As an example, the various operational components of the system 100 can be coupled to the frame 164.

Referring to FIGS. 1-6, 9 and 21, in one or more examples, the system 100 includes a carrier-guide 166. The carrier-guide 166 is coupled to the frame 164. As best illustrated in FIGS. 7-9, the carrier-guide 166 is configured to direct movement of the carrier 108 relative to the dispenser 112. As an example, the carrier-guide 166 appropriately directs and routes the carrier 108 (e.g., the tape 128) along a portion of the processing path 196 from the supply roller 210 to a position (e.g., location and orientation) relative to the nozzle 138 for discharge of the viscous material 102 from the canister 134 onto the carrier-surface 124 of the carrier 108 in the form of the strip 144 of the viscous material 102.

Referring to FIGS. 1-9 and 21, the system 100 includes a nozzle-holder 168. The nozzle-holder 168 is coupled to the frame 164. The nozzle-holder 168 is configured to fix a position of the nozzle 138 relative to the carrier-guide 166. In one or more examples, the nozzle-holder 168 is coupled to the canister 134 and the frame 164 to fix the position of the nozzle 138 for example relative to the carrier 108 or the carrier-guide 166. In one or more examples, the nozzle-holder 168 is coupled to the nozzle 138 and to the frame 164 to fix the position of the nozzle 138 for example relative to the carrier 108 or the carrier-guide 166. In one or more examples, the nozzle-holder 168 includes one or more brackets. In one or more examples, the nozzle-holder 168 and/or the carrier-guide 166 are movable relative to one another and relative to the frame 164 such that the position of the nozzle 138 is adjustable.

Referring to FIGS. 1-8, 10-13 and 21, in one or more examples, the applicator 114 includes a gripper 172, a carrier-support 170, and an actuator 198. The gripper 172 is configured to hold the fastener 104 relative to the carrier 108. The carrier-support 170 is configured to support the carrier 108 during transfer of the viscous material 102 from the carrier 108 to the fastener 104. The carrier-support 170 is configured to position the carrier 108 relative to the gripper 172. The actuator 198 is configured to selectively move at least one of the gripper 172 and the carrier 108 toward or away from each other to apply the viscous material 102 to the fastener 104 (e.g., transfer the viscous material 102 from the carrier-surface 124 of the carrier 108 to the fastener-surface 106 of the fastener 104).

Referring generally to FIGS. 1-8 and 21 and particularly to FIG. 10, in one or more examples, the gripper 172 includes a gripper-support 180. The gripper-support 180 is coupled to the frame 164. In one or more examples, the gripper-support 180 is movable relative to the frame 164 to adjust the location of the gripper 172. The gripper 172 includes a first gripper-arm 174. The first gripper-arm 174 is coupled to the gripper-support 180. The gripper 172 includes a second gripper-arm 176. The second gripper-arm 176 is coupled to the gripper-support 180. The gripper 172 includes a gripper-arm-actuator 178. The gripper-arm-actuator 178 is configured to selectively move the first gripper-arm 174 and the second gripper-arm 176 toward or away from each other. In one or more examples, the gripper-arm-actuator 178 is configured to move the first gripper-arm 174 and the second gripper-arm 176 between an open position and a closed position. Movement of the first gripper-arm 174 and the second gripper-arm 176 relative to each other (e.g., between the open and closed positions) enables the gripper 172 to selectively grasp and hold the fastener 104 (e.g., as shown in FIG. 10) during transfer of the viscous material 102 from the carrier 108 to the fastener-surface 106 of the fastener 104 and release the fastener 104 after transfer of the viscous material 102.

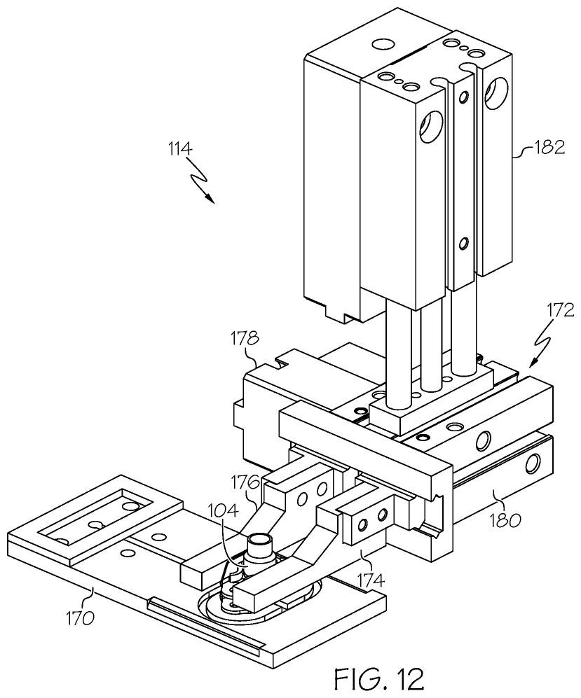

Referring to FIGS. 12, 13 and 21, in one or more examples, the actuator 198 includes a gripper-actuator 182. The gripper-actuator 182 is coupled to the gripper 172, such as to the gripper-support 180. The gripper-actuator 182 is configured to move the gripper-support 180 relative to the carrier 108.

In one or more examples, the gripper 172 is moved to the closed position to grasp and hold the fastener 104. With the first gripper-arm 174 and the second gripper-arm 176 in the closed position and the fastener 104 held between the first gripper-arm 174 and the second gripper-arm 176, the gripper-actuator 182 moves (e.g., lowers) the gripper 172 toward the carrier-support 170. Movement of the gripper 172 toward the carrier-support 170 in turn moves the gripper 172 and, thus, the fastener 104, toward the carrier 108 being supported on the carrier-support 170 and, thus, toward the strip 144 of the viscous material 102. Movement of the fastener 104 toward the carrier 108 in turn engages (e.g., presses or dips) the fastener-surface 106 of the fastener 104 into the strip 144 of the viscous material 102 located on the carrier-surface 124 of the carrier 108.

In one or more examples, the gripper-actuator 182 is a linear actuator. In one or more examples, the gripper-actuator 182 is a pneumatic actuator. In one or more examples, the gripper-actuator 182 is an electro-mechanical actuator. In one or more examples, the gripper-actuator 182 is a hydraulic actuator.

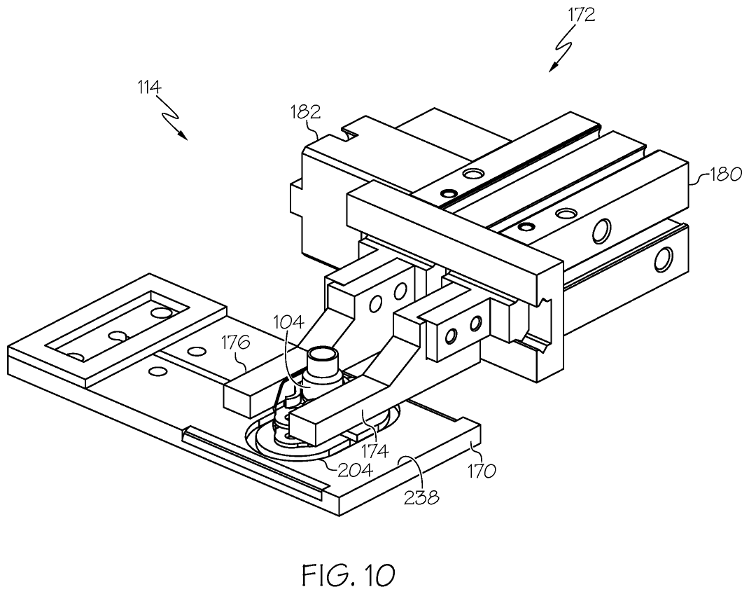

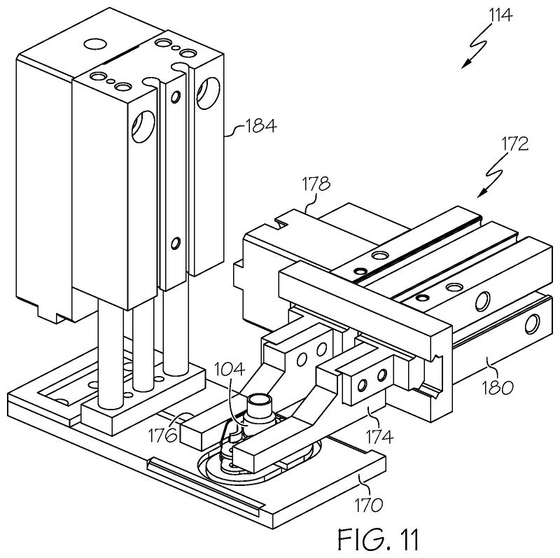

Referring to FIGS. 11, 13 and 21, in one or more examples, the actuator 198 includes a carrier-support-actuator 184. The carrier-support-actuator 184 is coupled to the carrier-support 170. The carrier-support-actuator 184 is configured to move the carrier-support 170 relative to the gripper 172.

In one or more examples, the gripper 172 is moved to the closed position to grasp and hold the fastener 104. With the first gripper-arm 174 and the second gripper-arm 176 in the closed position and the fastener 104 held between the first gripper-arm 174 and the second gripper-arm 176, the carrier-support-actuator 184 moves (e.g., raises) a portion of the carrier 108 toward the gripper 172. Movement of the carrier-support 170 toward the gripper 172 in turn moves the carrier 108 being supported on the carrier-support 170 and, thus, the strip 144 of the viscous material 102, toward the gripper 172 and, thus, the fastener 104 being held by the gripper 172. Movement of the carrier 108 toward the fastener 104 in turn engages (e.g., pressed or dips) the fastener-surface 106 of the fastener 104 into the strip 144 of the viscous material 102 located on the carrier-surface 124 of the carrier 108.

In one or more examples, the carrier-support-actuator 184 is a linear actuator. In one or more examples, the carrier-support-actuator 184 is a pneumatic actuator. In one or more examples, the carrier-support-actuator 184 is an electro-mechanical actuator. In one or more examples, the carrier-support-actuator 184 is a hydraulic actuator.

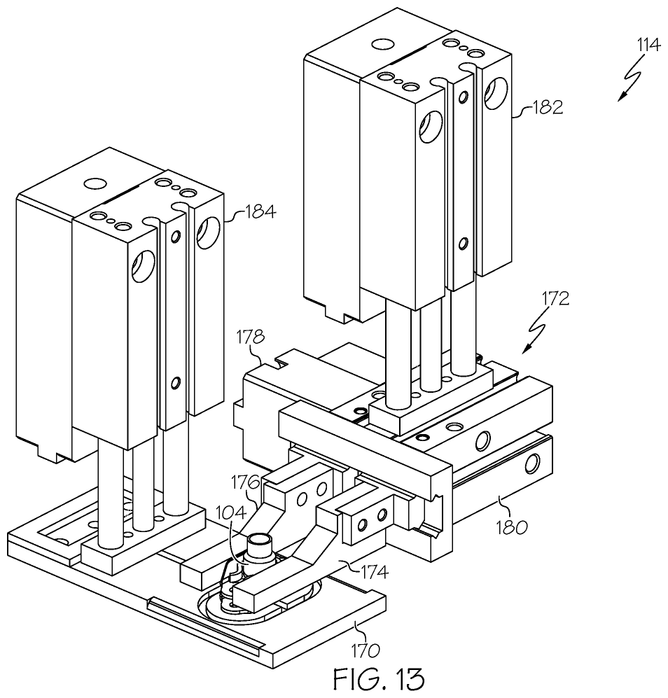

Referring to FIGS. 13 and 21, in one or more examples, the actuator 198 includes the carrier-support-actuator 184, coupled to the carrier-support 170, and the gripper-actuator 182 is coupled to the gripper 172. In these examples, the gripper-actuator 182 moves the gripper-172 relative to (e.g., toward and away from) the carrier-support 170 and, thus, the carrier 108, and the carrier-support-actuator 184 moves the carrier-support 170 relative to (e.g., toward and away from) the gripper 172, and thus, the fastener 104.

Referring to FIGS. 1-8 and 21, in one or more examples, the system 100 includes a sensor 116. In one or more examples, the sensor 116 is configured to detect the viscous material 102 on the carrier 108. In one or more examples, the sensor 116 is configured to detect the viscous material 102 on the fastener 104. In one or more examples, the sensor 116 includes or takes the form of an optical sensor 200 (e.g., a camera). In one or more examples, the sensor 116 includes or takes the form of a laser sensor 202 (e.g., a laser scanner).

In one or more examples, the sensor 116 detects the strip 144 of the viscous material 102 on the carrier-surface 124 of the carrier 108. Signals and/or data (e.g., images or leaser measurements) generated by the sensor 116 can be analyzed and used to determine and/or verify that the viscous material 102 is dispensed properly. As an example, the dimensions of the strip 144 can be measured. As another example, gaps or openings in the viscous material 102 forming the strip 144 can be detected. In other examples, the sensor 116 can be used to detect the location of the strip 144 relative to the fastener 104 such that a closed-loop feedback control can be utilized to control movement of the carrier 108 along the processing path 196.

In one or more examples, the sensor 116 detects the viscous material 102 on the fastener-surface 106 of the fastener 104. Signals and/or data (e.g., images or leaser measurements) generated by the sensor 116 can be analyzed and used to determine and/or verify that the viscous material 102 is properly covering the fastener-surface 106 of the fastener 104. As an example, a percentage of surface coverage and/or thickness of the viscous material 102 on the fastener-surface 106 can be calculated or determined. In one or more examples, the gripper 172 is configured to manipulate or adjust the orientation of the fastener 104 after transfer of the viscous material 102 such that the fastener-surface 106 is in the field of view of the sensor 116. In another example, the carrier 108 is transparent such that the sensor 116 can detect the viscous material 102 on the fastener-surface 106 of the fastener 104 through the carrier 108.

Referring to FIG. 21, in one or more examples, the system 100 can include a second sensor 188 (and additional sensors) as needed for verification of application and coverage. As an example, the sensor 116 can be suitable positioned to detect the viscous material 102 on the carrier 108 before and/or after transfer. In one or more examples, the second sensor 188 is configured to detect the viscous material 102 on the fastener 104 after transfer.

In the illustrated examples, the fastener-surface 106 of the fastener 104, to which the viscous material 102 is applied, is generally or substantially planar (e.g., flat). As an example, the contact surface of the base plate of the nut plate 206 is substantially flat. In these examples, the carrier-support 170 includes a carrier-support-surface 238 that is also substantially planar and that corresponds to the shape of the fastener 104. However, the teachings of the system 100 and the method 1000 disclosed herein are not limited to fasteners having flat application surfaces. In one or more examples, the carrier-support-surface 238 of the carrier-support 170 includes a contoured or other non-planar profile or shape that corresponds to a contour or non-planar shape of the fastener-surface 106 of the fastener 104. As an example, the carrier-support-surface 238 forms a die 204 that accommodates or receives at least a portion of the fastener 104 such that the viscous material 102 can be transferred to the fastener-surface 106. In these examples, the carrier 108 is flexible and conforms to the shape of the fastener-surface 106 during transfer of the viscous material 102 and when the carrier 108 and the strip 144 of the viscous material 102 are compressed between the die 204 and the fastener 104.

Referring to FIGS. 1-5 and 21, in one or more examples, the system 100 includes the carrier 108 that supports the viscous material 102 and the dispenser 112 that dispenses the viscous material 102 on the carrier 108. The system 100 also includes an end effector 192. The end effector 192 is configured to manipulate the fastener 104. The system 100 includes a robotic arm 190. The robotic arm 190 is configured to move the end effector 192 relative to the carrier 108. The system 100 includes the carrier-support 170 that supports the carrier 108 during transfer of a portion of the viscous material 102 from the carrier 108 to the fastener 104.

Referring to FIG. 21, in one or more examples, the system 100 includes a carousel 194. The carousel 194 is configured to hold the fastener 104. In some examples, the carousel 194 is configured to hold any number of fasteners throughout application of the viscous material 102 and installation of the fastener 104. In these examples, the robotic arm 190 is configured to retrieve the fastener 104 from the carousel 194 before application of the viscous material 102. The robotic arm 190 is configured to then position the end effector 192 and, thus, the fastener 104, relative to the carrier-support 170 for transfer of the viscous material 102. The robotic arm 190 is configured to return the fastener 104 to the carousel 194 after application of the viscous material 102. This process can be repeated for each one of the fasteners held by the carousel 194.

Referring to FIGS. 1-5 and 21, in one or more examples, the system 100 includes the carrier-support-actuator 184. The carrier-support-actuator 184 is coupled to the carrier-support 170. The carrier-support-actuator 184 moves the carrier-support 170 relative to the end effector 192.

In one or more examples, the end effector 192 is moved to an appropriate position using the robotic arm 190 such that the fastener 104 is appropriately located for transfer of the viscous material 102. With the fastener 104 held by the end effector 192, the carrier-support-actuator 184 moves (e.g., raises) a portion of the carrier 108 toward the end effector 192. Movement of the carrier-support 170 toward the end effector 192 in turn moves the carrier 108 being supported on the carrier-support 170 and, thus, the strip 144 of the viscous material 102, toward the end effector 192 and, thus, the fastener 104 being held by the end effector 192. Movement of the carrier 108 toward the fastener 104 in turn engages (e.g., pressed or dips) the fastener-surface 106 of the fastener 104 into the strip 144 of the viscous material 102 located on the carrier-surface 124 of the carrier 108.

Referring to FIGS. 1-5 and 21, in one or more examples, the system 100 includes the gripper 172. The gripper 172 holds the fastener 104 relative to the end effector 192. In some examples, the end effector 192 is not configured to securely hold the fastener 104 in a fixed position. As such, in these examples, the gripper 172 is used to fix the position (e.g., location and orientation) of the fastener 104 while the fastener 104 is still being held by the end effector 192.

Referring to FIGS. 1-5 and 21, in one or more examples, the system 100 includes the carrier-support-actuator 184. The carrier-support-actuator 184 is coupled to the carrier-support 170. The carrier-support-actuator 184 moves the carrier-support 170 relative to the gripper 172.

Referring to FIGS. 1-5 and 21, in one or more examples, the system 100 includes the gripper-actuator 182. The gripper-actuator 182 is coupled to the gripper 172. The gripper-actuator 182 moves the gripper 172 relative to the carrier-support 170. In one or more examples, the end effector 192 hands of or otherwise transfers the fastener 104 to the gripper 172 for application of the viscous material 102. In these examples, once the gripper 172 grasps the fastener 104, the end effector 192 releases the fastener 104. After transferring viscous material 102 to the fastener 104, the end effector 192 retrieves the fastener 104 from the gripper 172.

Referring to FIG. 21, in one or more examples, the system 100 includes a controller 236. The controller 236 is configured to control one or more of the operational components of the system 100. As examples, the controller 236 is in communication with and/or provides instructions or commands to the dispenser-drive 136, the actuator 198, the feeder-drive 132, the sensor 116, the end effector 192, the robotic arm 190, and other operational components.

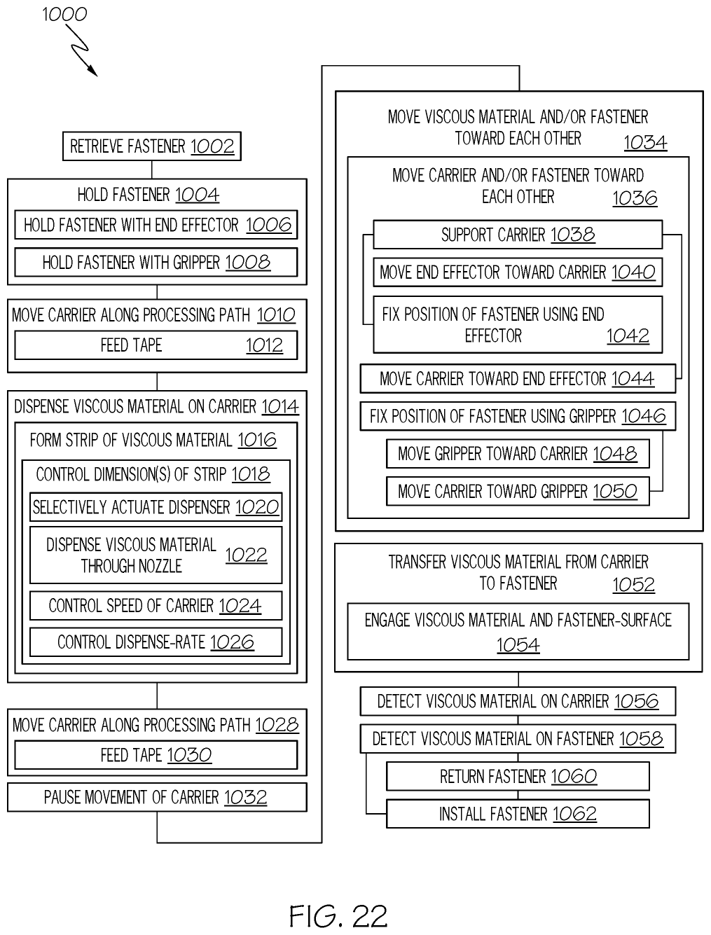

Referring generally to FIGS. 1-21 and particularly to FIG. 22, the following are examples of the method 1000, according to the present disclosure. In one or more examples, the method 1000 is implemented using the system 100 (FIG. 1-21). The method 1000 includes a number of elements, steps, and/or operations. Not all of the elements, steps, and/or operations described or illustrated in one example are required in that example. Some or all of the elements, steps, and/or operations described or illustrated in one example can be combined with other examples in various ways without the need to include other elements, steps, and/or operations described in those other examples, even though such combination or combinations are not explicitly described or illustrated by example herein.

In one or more examples, the method 1000 includes a step of (block 1002) retrieving the fastener 104. In one or more examples, the fastener 104 is retrieved using the robotic arm 190 and the end effector 192. In one or more examples, the fastener 104 is received from the carousel 194. Generally, the fastener 104 is retrieved (e.g., block 1002) before transferring the viscous material 102 to the fastener-surface 106 of the fastener 104 (e.g., block 1050).

In one or more examples, the method 1000 includes a step of (block 1004) holding the fastener 104. In one or more examples, the step of (block 1004) holding the fastener 104 includes a step of (block 1006) holding the fastener 104 with the end effector 192 of the robotic arm 190. In one or more examples, the step of (block 1004) holding the fastener 104 includes a step of (block 1008) holding the fastener 104 with the gripper 172.

The method 1000 includes a step of (block 1010) moving the carrier 108 along the processing path 196 relative to the dispenser 112. In one or more examples, the carrier 108 includes a continuous length of the tape 128. The step of moving the carrier 108 along the processing path 196 (e.g., block 1010) includes a step of (block 1012) feeding the tape 128 along the processing path 196.

The method 1000 includes a step of (block 1014) dispensing the viscous material 102 from the dispenser 112 onto the carrier-surface 124 of the carrier 108. Dispensing the viscous material 102 (e.g., block 1014) is performed while moving the carrier 108 along the processing path 196 (e.g., block 1010).

In one or more examples, the step of (block 1014) dispensing the viscous material 102 includes a step of (block 1016) forming the strip 144 of the viscous material 102 on the carrier-surface 124 of the carrier 108.

In one or more examples, the step of (block 1016) forming the strip 144 of the viscous material 102 on the carrier-surface 124 of the carrier 108 includes a step of (block 1018) controlling one or more dimensions of the strip 144.

In one or more examples, the step of (block 1016) controlling the dimensions includes a step of controlling the strip-length 156 of the strip 144 such that the strip-length 156 is greater than or equal to the fastener-length 160 of the fastener-surface 106.

In one or more examples, the step of (block 1014) dispensing the viscous material 102 includes as step of (block 1020) selectively actuating the dispenser 112. In one or more examples, selective actuation of the dispenser 112 is used to control one or more of the dimensions of the strip 144 (e.g., block 1018). As an example, the step of (block 1018) controlling the dimensions includes the step of (block 1020) selectively actuating the dispenser 112, thereby controlling the strip-length 156.

In one or more examples, the step of (block 1016) forming the strip 144 of the viscous material 102 on the carrier-surface 124 of the carrier 108, such as the step of (block 1018) controlling one or more dimensions of the strip 144, includes a step of controlling the strip-width 158 of the strip 144 such that the strip-width 158 is greater than or equal to the fastener-width 152 of the fastener-surface 106 and the strip-width 158 is less than the carrier-width 154 of the carrier 108.

In one or more examples, the step of (block 1018) controlling one or more dimensions of the strip 144, such as the step of controlling the strip-width 158, includes a step of (block 1022) dispensing the viscous material 102 through the nozzle 138 that includes the slot 140.

In one or more examples, the step of (block 1016) forming the strip 144 of the viscous material 102 on the carrier-surface 124 of the carrier 108, such as the step of (block 1018) controlling one or more dimensions of the strip 144, includes a step of controlling the strip-thickness 162 of the strip 144.

In one or more examples, the step of (block 1018) controlling one or more dimensions of the strip 144, such as the step of controlling the strip-thickness 162, includes a step of (block 1024) controlling a speed of movement of the carrier 108 relative to the dispenser 112 along the processing path 196 and a step of (block 1026) controlling a dispense-rate of the viscous material 102 from the dispenser 112.

The method 1000 includes a step of (block 1028) moving the carrier 108 along the processing path 196 relative to the fastener 104. Moving the carrier 108 (e.g., block 1028) is performed after dispensing the viscous material 102 (e.g., block 1014). In one or more examples, the carrier 108 includes a continuous length of the tape 128. The step of moving the carrier 108 along the processing path 196 (e.g., block 1028) includes a step of (block 1030) feeding the tape 128 along the processing path 196.

The method 1000 includes a step of (block 1032) pausing movement of the carrier 108 along the processing path 196. Pausing movement (e.g., block 1032) facilitates transfer of the viscous material 102 from the carrier 108 to the fastener 104.

The method 1000 includes a step of (block 1034) moving at least one of the viscous material 102 and the fastener 104 toward each other. As an example, the step of (block 1034) moving includes a step of (block 1036) moving at least one of the carrier 108 and the fastener 104 toward each other. Moving the carrier 108, and thereby the viscous material 102, and/or the fastener 104 (e.g., block 1036) is performed while pausing movement of the carrier 108 along the processing path 196 (e.g., block 1032).

In one or more examples, the step of (block 1036) moving at least one of the carrier 108 and the fastener 104 toward each other includes a step of (block 1038) supporting the carrier 108 and a step of (block 1040) moving the end effector 192 toward the carrier 108 using the robotic arm 190 such that the fastener-surface 106 engages the viscous material 102 on the carrier-surface 124 of the carrier 108. The carrier 108 is supported by the carrier-support 170. The fastener 104 is moved and held in an appropriate position by the end effector 192.

In one or more examples, the step of (block 1036) moving at least one of the carrier 108 and the fastener 104 toward each other includes a step of (block 1042) fixing a position of the fastener 104 using the end effector 192 and the robotic arm 190, the step of (block 1038) supporting the carrier 108, and a step of (block 1044) moving the carrier 108 toward the end effector 192, holding the fastener 104, such that the viscous material 102 on the carrier-surface 124 of the carrier 108 engages the fastener-surface 106.

In one or more examples, the step of (block 1036) moving at least one of the carrier 108 and the fastener 104 toward each other includes a step of (block 1046) fixing a position of the fastener 104 using the gripper 172, the step of (block 1038) supporting the carrier 108, and a step of (block 1048) moving the gripper 172 toward the carrier 108 such that the fastener-surface 106 engages the viscous material 102 on the carrier-surface 124 of the carrier 108.

In one or more examples, the step of (block 1036) moving at least one of the carrier 108 and the fastener 104 toward each other includes the step of (block 1046) fixing a position of the fastener 104 using the gripper 172, the step of (block 1038) supporting the carrier 108, and a step of (block 1050) moving the carrier 108 toward the gripper 172 and, thus, the fastener 104, such that the viscous material 102 on the carrier-surface 124 of the carrier 108 engages the fastener-surface 106.

The method 1000 includes a step of (block 1052) transferring a portion of the viscous material 102 from the carrier-surface 124 of the carrier 108 to the fastener-surface 106 of the fastener 104. The viscous material 102 is transferred from the carrier-surface 124 to the fastener-surface 106 of the fastener 104 in response to the moving the viscous material 102 and the fastener 104 toward one another (e.g., block 1034). In one or more examples, the step of (block 1052) transferring the viscous material 102 from the carrier 108 to the fastener 104 includes a step of (block 1054) engaging (e.g., pressing or dipping) the fastener-surface 106 of the fastener 104 into the strip 144 of the viscous material 102 on the carrier-surface 124 of the carrier 108.

In one or more examples, the method 1000 includes a step of (block 1056) detecting the viscous material 102 on the carrier-surface 124 of the carrier 108. In one or more examples, the viscous material 102 is detected using the sensor 116. In one or more examples, the viscous material 102 on the carrier 108 is measured, validated, or otherwise inspected using information provided by the sensor 116.

In one or more examples, the method 1000 includes a step of (block 1058) detecting the viscous material 102 on the fastener-surface 106 of the fastener 104. In one or more examples, the viscous material 102 is detected using the sensor 116. In one or more examples, the viscous material 102 on the fastener-surface 106 of the fastener 104 is measured, validated, or otherwise inspected using information provided by the sensor 116.

In one or more examples, the method 1000 includes a step of (block 1060) returning the fastener 104 to the carousel 194 after transferring the viscous material 102 to the fastener-surface 106 of the fastener 104 (e.g., block 1052). In one or more examples, the fastener 104 is returned (e.g., block 1060) using the end effector 192 and the robotic arm 190.

In one or more examples, the method 1000 includes a step of (block 1062) installing the fastener 104 to join two or more components of a structure after transferring the viscous material 102 to the fastener-surface 106 of the fastener 104 (e.g., block 1052). In one or more examples, the fastener 104 is installed (e.g., block 1062) using the end effector 192 and the robotic arm 190.

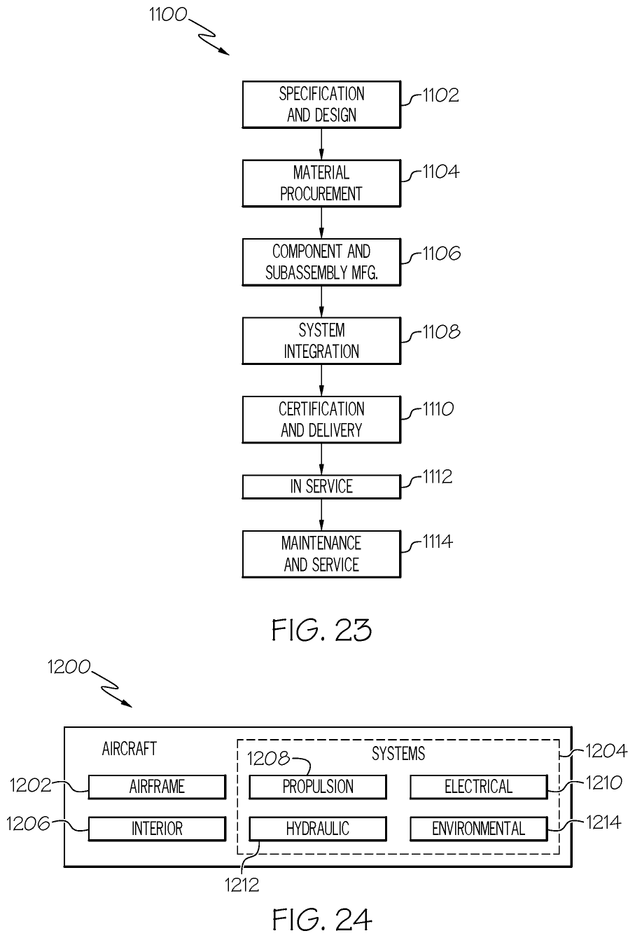

Referring now to FIGS. 23 and 24, examples of the system 100 and the method 1000 described herein, may be related to, or used in the context of, the aircraft manufacturing and service method 1100, as shown in the flow diagram of FIG. 23 and the aircraft 1200, as schematically illustrated in FIG. 24. As an example, the aircraft 1200 and/or the aircraft production and service method 1100 may include or utilize the system 100 and/or the method 1000 for conveying gas, such as air, to desired spaces during manufacture or during service.

Referring to FIG. 24, which illustrates an example of the aircraft 1200. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like. The aircraft 1200 can have any number of components that are joined using fasteners with viscous material (e.g., sealant or adhesive) applied using the system 100 and/or according to the method 1000.

Referring to FIG. 23, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 23 may be performed or carried out by a system integrator, a third party, and/or an operator (e.g., a customer). For the purposes of this description, a system integrator may include, without limitation, any number of spacecraft manufacturers and major-system subcontractors; a third party may include, without limitation, any number of vendors, subcontractors, and suppliers; and an operator may be an airline, leasing company, military entity, service organization, and so on.

Examples of the system 100 and the method 1000 shown and described herein, may be employed during any one or more of the stages of the manufacturing and service method 1100 shown in the flow diagram illustrated by FIG. 23. In an example, components of the aircraft 1200 can be joined using fasteners that have a viscous material (e.g., sealant or adhesive) applied using the system 100 and/or according to the method 1000 during a portion of component and subassembly manufacturing (block 1106) and/or system integration (block 1108). Further, components of the aircraft 1200 can be joined using fasteners that have a viscous material (e.g., sealant or adhesive) applied using the system 100 and/or according to the method 1000 while the aircraft 1200 is in service (block 1112). Also, components of the aircraft 1200 can be joined using fasteners that have a viscous material (e.g., sealant or adhesive) applied using the system 100 and/or according to the method 1000 during system integration (block 1108) and certification and delivery (block 1110). Similarly, components of the aircraft 1200 can be joined using fasteners that have a viscous material (e.g., sealant or adhesive) applied using the system 100 and/or according to the method 1000 while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1-21 and 24, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-21 and 24, referred to above, need be included in every example and not all elements, features, and/or components described herein are necessarily depicted in each illustrative example. Accordingly, some of the elements, features, and/or components described and illustrated in FIGS. 1-21 and 24 may be combined in various ways without the need to include other features described and illustrated in FIGS. 1-21 and 24, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-21 and 24, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-21 and 24, and such elements, features, and/or components may not be discussed in detail herein with reference to each of FIGS. 1-21 and 24. Similarly, all elements, features, and/or components may not be labeled in each of FIGS. 1-21 and 24, but reference numerals associated therewith may be utilized herein for consistency.

In FIGS. 22 and 23, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 22 and 23 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the system 100 and the method 1000 have been shown and described, modifications may occur to those skilled in the art upon reading the specification. The present application includes such modifications and is limited only by the scope of the claims.

What is claimed is:

1. A system for applying viscous material to a fastener, the system comprising:
a carrier that supports the viscous material;
a dispenser that dispenses the viscous material on the carrier; and
an applicator that supports at least one of the carrier and the fastener and transfers a portion of the viscous material from the carrier to the fastener.

2. The system of claim 1, further comprising a feeder that moves the carrier relative to the dispenser and the applicator.

3. The system of claim 2, wherein:
the carrier comprises a continuous length of tape; and
the feeder comprises:
a roll that stores the tape; and
a feeder-drive that removes the tape from the roll and moves the tape relative to the dispenser and the applicator.

4. The system of claim 3, wherein the feeder-drive incrementally progresses the tape relative to the applicator.

5. The system of claim 1, wherein:
the dispenser comprises:
a canister that holds the viscous material and comprises an outlet;
a dispenser-drive that forces the viscous material from the canister and through the outlet; and
a nozzle that is coupled to the outlet of the canister; and
the nozzle comprises a slot that forms a strip of the viscous material on the carrier.

6. The system of claim 5, wherein:
the slot comprises a slot-length;
the slot-length is greater than or equal to a fastener-width of the fastener; and
the slot-length is less than a carrier-width of the carrier.

7. The system of claim 5, wherein:
the dispenser-drive is selectively actuated to dispense the viscous material such that the strip of the viscous material has a strip-length; and
the strip-length is greater than a fastener-length of the fastener.

8. The system of claim 6, wherein:
the carrier is movable relative to the dispenser; and
a speed of movement of the carrier relative to the dispenser and a dispense-rate of the viscous material from the dispenser are selectively controlled to control a strip-thickness of the strip of the viscous material.

9. The system of claim 1, wherein the applicator comprises:
a gripper that holds the fastener relative to the carrier; and
an actuator that selectively moves at least one of the gripper and the carrier toward or away from each other to apply the viscous material to the fastener.

10. The system of claim 9, wherein the actuator comprises a gripper-actuator that is coupled to the gripper and that moves the gripper relative to the carrier.

11. The system of claim 9, wherein the applicator further comprises a carrier-support that positions the carrier relative to the gripper.

12. The system of claim 11, wherein the actuator comprises a carrier-support-actuator that is coupled to the carrier-support and moves the carrier-support relative to the gripper.

13. The system of claim 1, further comprising a sensor that detects at least one of the viscous material on the carrier and the viscous material on the fastener.

14. A system for applying viscous material to a fastener, the system comprising:
a carrier that supports the viscous material;
a dispenser that dispenses the viscous material on the carrier;
an end effector that manipulates the fastener;
a robotic arm that moves the end effector relative to the carrier; and
a carrier-support that supports the carrier during transfer of a portion of the viscous material from the carrier to the fastener,
wherein the carrier is movable relative to the dispenser and the carrier-support.

15. The system of claim 14, further comprising a carrier-support-actuator that is coupled to the carrier-support and moves the carrier-support relative to the end effector.

16. The system of claim 14, further comprising a gripper that holds the fastener relative to the end effector.

17. The system of claim 16, further comprising a carrier-support-actuator that is coupled to the carrier-support and moves the carrier-support relative to the gripper.

18. The system of claim 14, further comprising a gripper-actuator that is coupled to the gripper and moves the gripper relative to the carrier-support.

19. A method for applying viscous material to a fastener, the method comprising steps of:
holding the fastener;
moving a carrier along a processing path relative to a dispenser;
while moving the carrier along the processing path, dispensing the viscous material from the dispenser onto a carrier-surface of the carrier;
after dispensing the viscous material, moving the carrier along the processing path relative to the fastener;
pausing movement of the carrier along the processing path;
while pausing movement of the carrier along the processing path, moving at least one of the carrier and the fastener toward each other; and
transferring a portion of the viscous material from the carrier-surface of the carrier to a fastener-surface of the fastener.

20. The method of claim 19, wherein the step of dispensing the viscous material comprises a step of forming a strip of the viscous material on the carrier-surface of the carrier.
